(19) United States
(12) Patent Application Publication
(10) Pub. No.: US 2017/0144373 A1
(43) Pub. Date: May 25, 2017

(54) METHOD AND SYSTEM FOR THREE-DIMENSIONAL PRINTING OF CONDUCTIVE MATERIALS

(71) Applicants: Rebecca L. Erikson, Richland, WA (US); Janine R. Hutchison, Richland, WA (US); Christopher A. Barrett, Richland, WA (US); Josef F. Christ, Pasco, WA (US)

(72) Inventors: Rebecca L. Erikson, Richland, WA (US); Janine R. Hutchison, Richland, WA (US); Christopher A. Barrett, Richland, WA (US); Josef F. Christ, Pasco, WA (US)

(73) Assignee: BATTELLE MEMORIAL INSTITUTE, Richland, WA (US)

(21) Appl. No.: 14/949,494

(22) Filed: Nov. 23, 2015

(51) Int. Cl. B29C 67/00; B33Y 30/00; B33Y 70/00; B33Y 10/00

(52) U.S. Cl. CPC B29C 67/0081; B29C 67/0085; B33Y 10/00; B33Y 30/00; B33Y 70/00; B29K 2103/04

(57) ABSTRACT

Methods and systems for three-dimensional printing of conductive materials are disclosed. A molten filament containing a conductive material is extruded from a print head of a three-dimensional printer. A magnetic field is applied to the print head. The magnetic field may be a magnet or an electromagnet. The magnetic field may be applied at the tip of the extruder, nozzle, or nozzle tip of the print head.

### STATEMENT REGARDING FEDERALLY SPONSORED RESEARCH OR DEVELOPMENT

This invention was made with Government support under Contract DE-AC05-76RL01830 awarded by the U.S. Department of Energy. The Government has certain rights in the invention.

### TECHNICAL FIELD

This invention relates to three-dimensional printing of filaments containing conductive materials. More specifically, this invention relates to application of a magnetic field to the filament during printing to increase or decrease the resistance and utility of the material.

### BACKGROUND

Many processes have been developed for biological and chemical detection that use traditional cleanroom facilities and lots of capital equipment to produce materials that can be functionalized for specific detection domains. For example, many new biological detectors use a mesh of polymer that has been electro-spun with carbon nano-tubes and activated by applying an antibody to these carbon locations. These types of detectors require very sophisticated laboratories for production and are hard to create in bulk.

### SUMMARY

The present invention is directed to methods and systems for three-dimensional printing of conductive materials. In one embodiment of the present invention, a method of three-dimensional printing of conductive materials is disclosed. The method includes extruding a molten filament containing a conductive material from a print head of a three-dimensional printer, and applying a magnetic field to the print head.

The magnetic field may be a magnet or an electromagnet.

In one embodiment, the filament is a polymer. The polymer may be, but is not limited to, acrylonitrile butadiene styrene (ABS), Nylon, polyethylene terephthalate (PET), or polylactic acid (PLA).

The conductive material may comprise at least one of the following: graphene, carbon black, multi-walled or single wall carbon nanotubes, a carbon nanotube composite, carbon fibers, a metal, metal nanoparticles, or combinations thereof.

In one embodiment, the print head comprises an extruder including a nozzle with a tip. The magnetic field may be applied at a tip of the extruder, nozzle, or nozzle tip of the print head.

The method may further include functionalizing the filament after the extruding and applying steps. In one embodiment, the filament is functionalized with an antibody.

In another embodiment of the present invention, a method of three-dimensional printing of conductive materials is disclosed. The method includes applying a magnetic field to a print head of a three-dimensional printer as an extruded molten filament containing a conductive material is being extruded through the print head.

In another embodiment of the present invention, a system for three-dimensional printing of a conductive material is disclosed. The system includes a filament containing a conductive material; a three-dimensional printer including a print head; and a magnetic field applied to the print head as the filament containing the conductive material is being extruded through the print head in a molten state.

In another embodiment of the present invention, a composition suitable for three-dimensional printing is disclosed. The composition includes a filament containing a conductive material, when exposed to a magnetic field and extruded through a print head of a three-dimensional printer, has a resistivity below 500 KOhms/cm.

In another embodiment of the present invention, an apparatus for three-dimensional printing is disclosed. The apparatus includes a three-dimensional printer including a print head, and a magnet or electromagnet coupled to the printer or the print head.

### BRIEF DESCRIPTION OF THE DRAWINGS

FIG. 1 is a picture of a two polymer (ABS) conductive filament materials, with the top filament printed without a magnetic field, and the bottom filament printed with an induced magnetic field.

FIGS. 2A-2D show SEM images of commercial conductive polymer (ABS) filaments with or without exposure to a magnetic field during printing. FIGS. 2A and 2C are unexposed filaments; FIGS. 2B and 2D are filaments exposed to the magnetic field.

### DETAILED DESCRIPTION OF THE PREFERRED EMBODIMENTS

The following description includes the preferred best mode of embodiments of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Disclosed are methods and systems for three-dimensional printing of conductive materials. In one embodiment, the method of three-dimensional printing of conductive materials includes extruding a molten filament containing a conductive material from a print head of a three-dimensional printer, and applying a magnetic field to the print head. The magnetic field may be, but is not limited to, a magnet or electromagnet.

The filament may be, but is not limited to a polymer. The polymer can be ABS, Nylon, PET, or PLA.

The conductive material is, but not limited to, at least one of the following: graphene, carbon black, multi-walled or single wall carbon nanotubes, a carbon nanotube composite, carbon fibers, a metal, metal nanoparticles, or combinations thereof.

In one embodiment, the print head comprises an extruder including a nozzle with a tip. The magnetic field may be applied to the tip of the extruder, nozzle or nozzle tip of the print head.

In another embodiment, a magnetic field is applied to the tip of a three-dimensional printer that is laying down fibers with paramagnetic fillers. The applied magnetic field causes the paramagnetic filler to be drawn to the surface of the fiber. Different field strengths, field alignments, and combinations of flux lines through magnetic or electromagnetic means can be used to further control and influence the structure of the material. After the magnetic field is applied, the printed filament may be labeled with antibodies.

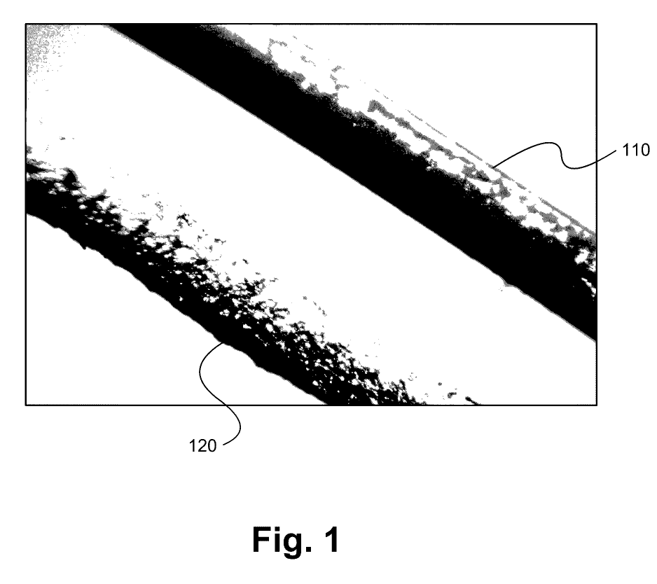

An increase in the conductivity of the material has been shown, as well as a surface roughness associated with more carbon locations on the outside of the material. FIG. 1 is a picture of a two black ABS conductive filament materials, with the top filament 110 printed without a magnetic field, and the bottom filament 120 printed with an induced magnetic field. The conductivity of the top fiber is an open state (greater than 10 Mohms), while the conductivity of the bottom fiber is in the 10's of KOhms/cm range. This result was reproduced three times on three separate prints.

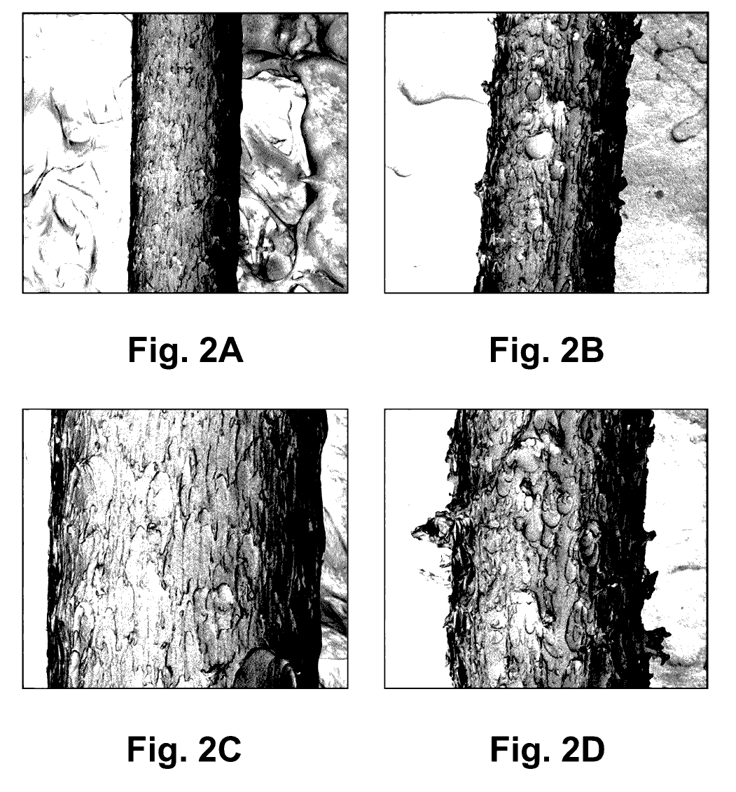

Scanning electron microscopy (SEM) was used to visualize the physical changes to the original filament and the filament exposed to a magnetic field, as shown in FIGS. 2A-2D. The unexposed filament of FIGS. 2A and 2C appears to have a smooth exterior with few aberrations and overall low surface roughness. Conversely, the filament exposed to a magnetic field, as shown in FIGS. 2B and 2D, has an increase in roughness and overall surface area. These images demonstrate that the magnetic field induction methods disclosed herein not only causes a measurable change in electrical resistance but causes the filament to change physically as well.

An important characteristic of a conductive filament that is used to detect a chemical or biological agent is that the measurable output (resistance) only changes in the presence of the target. Two untreated conductive filament and two filament exposed to the magnetic field were cut in half and the eight resultant segments were measured for their resistivity. Each filament was measured three times for n=12 measurements at time zero or prior to treatment, as detailed in Table 1 below. For filaments that were not in a buffer, the resistance of the untreated sample was 36 KOhms, the magnetic treated was 64 KOhms. The fold change in resistance was 1.7. For filaments placed in a 2 mL microfuge tube with 0.5 mL Phosphate buffered saline with 0.02% Tween 20 (PBST) solution the untreated filament had a resistance of 70 compared to the treated with 149 for a fold change of 2.1. To determine the effect of Bacillus anthracis Sterne spores, approximately 82 spores were added to treated or untreated filaments. The samples were mixed by inversion for approximately 90 minutes. Results are preliminary, but show promise and need to be repeated due to high standard deviation. Filament exposed to this particular magnetic field had an increase in resistance between 2.0 and 5.2 compared to the untreated filament. Additional experiments may need to be completed to determine if this variation is due to spore interaction with the filament.

TABLE 1
Average resistance of 3D printed filament. Filaments were
either exposed to magnetic field or not treated (filament
type). Filaments were then used for subsequent experiments
(treatment). Average resistance is average of 3 independent
measurements of 4 filaments (n = 12).

| | | Average | Standard |
|---|---|---|---|
| | | Resistance | Deviation |
| Filament Type | Treatment | (KOhms) | (KOhms) |
| Standard Printed | No treatment | 36 | 1 |
| Magnetic Printed | No treatment | 64 | 7 |
| Standard Printed | Buffer mixing | 70 | 8 |
| Magnetic Printed | Buffer mixing | 149 | 26 |
| Standard Printed | B. anthracis spores T = 0 | 45 | 9 |
| Magnetic Printed | B. anthracis spores T = 0 | 75 | 22 |
| Standard Printed | B. anthracis spores T = 90 | 84 | 15 |
| Magnetic Printed | B. anthracis spores T = 90 | 303 | 137 |

The present invention takes advantage of the paramagnetic properties of conductive materials, such as carbon additives, in commercial 3D printer filaments to control and direct the location and alignment of the carbon in the filament carrier by introducing a magnetic field around the liquid state of the material. Inducing this field while the filament, such as a polymer carrier, is in a liquid state allows for the mass transport of the conductive material, and as the polymer cools the carbon structures are fixed in the aligned state. Further, by controlling the mass transit of conductive sites in three-dimensional printed materials and increasing their local density on the outside of the extruded filament, commercially available and inexpensive materials can be used to create a biological or chemical detector by functionalizing the conductive sites with antibodies specific to the targeted biomarker or chemical. This will greatly reduce the cost, development time, and complexity of these types of detector systems.

Additionally, methods of the present invention can change the electrical properties of the material being used, as a localization of the conductive sites increases conductance of the material. This can be used to develop electrical systems on the printer, including printing of coils, motors, and electrical traces. By controlling the temporal state of the magnetic field, the material can be quickly changed from a conductor to an insulator, allowing for a single print material to be used to create complex designs.

The present invention allows for inexpensive and commercially available three-dimensional printers to produce sophisticated and functional materials quickly. The processes require very little capital equipment and can be done on, for example, a desk, in the back of a vehicle, or out in the field. The methods open up a wide variety of application possibilities in, for example, the electric and magnetic (E&M) space, through printing a polymer based material at a relatively low print temperature.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method of three-dimensional printing of conductive materials comprising:
a. extruding a molten filament containing a conductive material from a print head of a three-dimensional printer; and
b. applying a magnetic field to the print head.

2. The method of claim 1 wherein the magnetic field is a magnet or electromagnet.

3. The method of claim 1 wherein the filament comprises a polymer.

4. The method of claim 3 wherein the polymer is ABS, Nylon, PET, or PLA.

5. The method of claim 1 wherein the conductive material comprises at least one of the following: graphene, carbon black, multi-walled or single wall carbon nanotubes, a carbon nanotube composite, carbon fibers, a metal, metal nanoparticles, or combinations thereof.

6. The method of claim 1 wherein the print head comprises an extruder including a nozzle with a tip.

7. The method of claim 6 wherein the magnetic field is applied at a tip of the extruder, nozzle or nozzle tip of the print head.

8. The method of claim 1 further comprising functionalizing the filament after the extruding and applying steps.

9. The method of claim 8 wherein the filament is functionalized with an antibody.

10. A method of three-dimensional printing of conductive materials comprising: applying a magnetic field to a print head of a three-dimensional printer as an extruded molten filament containing a conductive material is being extruded through the print head.

11. A system for three-dimensional printing of a conductive material comprising:
a. a filament containing a conductive material;
b. a three-dimensional printer including a print head; and
c. a magnetic field applied to the print head as the filament containing the conductive material is being extruded through the print head in a molten state.

12. The system of claim 11 wherein the magnetic field is a magnet or electromagnet.

13. The system of claim 11 wherein the filament comprises a polymer.

14. The system of claim 13 wherein the polymer is ABS, Nylon, PET, or PLA.

15. The system of claim 11 wherein the conductive material comprises at least one of the following: graphene, carbon black, multi-walled or single wall carbon nanotubes, a carbon nanotube composite, carbon fibers, a metal, metal nanoparticles, or combinations thereof.

16. The system of claim 11 wherein the print head comprises an extruder including a nozzle with a tip.

17. The system of claim 16 wherein the magnetic field is applied at a tip of the extruder, nozzle or nozzle tip of the print head.

18. The system of claim 11 wherein the filament is functionalized after the filament is extruded and the magnetic field applied.

19. The system of claim 18 wherein the filament is functionalized with an antibody

20. A composition suitable for three-dimensional printing comprising: a filament containing a conductive material, when exposed to a magnetic field and extruded through a print head of a three-dimensional printer, has a resistivity below approximately 500 KOhms/cm.

21. The composition of claim 20 wherein the filament comprises a polymer.

22. The composition of claim 21 wherein the polymer is ABS, Nylon, PET, or PLA.

23. The composition of claim 20 wherein the conductive material comprises at least one of the following: graphene, carbon black, multi-walled or single wall carbon nanotubes, a carbon nanotube composite, carbon fibers, a metal, metal nanoparticles, or combinations thereof.

24. An apparatus for three-dimensional printing comprising:
a. a three-dimensional printer including a print head; and
b. a magnet or electromagnet coupled to the printer or the print head.

25. The apparatus of claim 24 wherein the print head comprises an extruder including a nozzle with a tip.
